(19) United States
(12) Patent Application Publication
(10) Pub. No.: US 2017/0124963 A1
(43) Pub. Date: May 4, 2017

(54) DISPLAY ADJUSTMENT METHOD AND ELECTRONIC DEVICE THEREOF

(71) Applicant: ACER INCORPORATED, New Taipei City (TW)

(72) Inventor: Jun-Liang Lu, New Taipei City (TW)

(21) Appl. No.: 15/068,627

(22) Filed: Mar. 13, 2016

(30) Foreign Application Priority Data
Nov. 4, 2015 (TW) 104136248

(51) Int. Cl. G09G 3/36

(52) U.S. Cl. CPC G09G 3/3607; G09G 2320/0242

(57) ABSTRACT

The invention provides a display adjustment method and an electronic device. The display adjustment method includes obtaining environmental information during capturing an image and display characteristic information of a display device, determining a display adjusting parameter according to the environmental information during capturing the image and the display characteristic information of the display, and controlling the display device for displaying the image according to the display adjusting parameter.

### BACKGROUND OF THE INVENTION

1. Field of the Invention

The present invention relates to a display adjustment method and an electronic device, and more particularly, to a display adjustment method and an electronic device capable of adjusting a display device according to the environmental information during capturing the image and the display characteristic information of the display device.

2. Description of the Prior Art

With the development of the technology and the improvement of industry, the functions of the digital camera have been widely applied in various portable electronic products, such as mobile phone, tablet computer, wearable device and notebook and so on. Moreover, the user usually utilizes the community websites or the cloud software to share the image captured by the digital camera equipped in the portable devices. However, since each display device of the electronic products may have respective display characteristics (such as display brightness and color and so on). When the same picture is displayed in different display devices, the display results on different display devices may be different, thus resulting in picture distortion. For example, please refer to FIG. 1, the electronic devices 10_1˜10_3 are a mobile phone, a tablet computer and a notebook respectively. The picture image can be displayed by the display devices assembled in the electronic devices 10_1˜10_3. As shown in FIG. 1, each display device of the electronic devices represents different display brightness, display color and display tone when displaying the same picture image. In other words, the display results displayed the same picture image indifferent devices are different. Therefore, the prior art should be improved necessarily.

### SUMMARY OF THE INVENTION

To achieve the above objective, the present invention provides a display adjustment method and an electronic device to adjust a display device according to environmental information during capturing an image and display characteristic information of the display device, and to achieve the display effect which the picture displayed in different display devices are consistent.

The present invention discloses a display adjustment method for a display device comprising: obtaining environmental information during capturing an image and display characteristic information of the display device; determining a display adjusting parameter according to the environmental information during capturing the image and the display characteristic information of the display device; and controlling the display device for displaying the image according to the display adjusting parameter.

The present invention further discloses an electronic device with display adjustment comprising: a display device; an information extraction unit for acquiring environmental information during capturing an image and display characteristic information of the display device; a processing unit for determining a display adjusting parameter according to the environmental information during capturing the image and the display characteristic information of the display device; and an adjustment unit for controlling the display device for displaying the image according to the display adjusting parameter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating utilizing different display devices for displaying image according to the prior art.

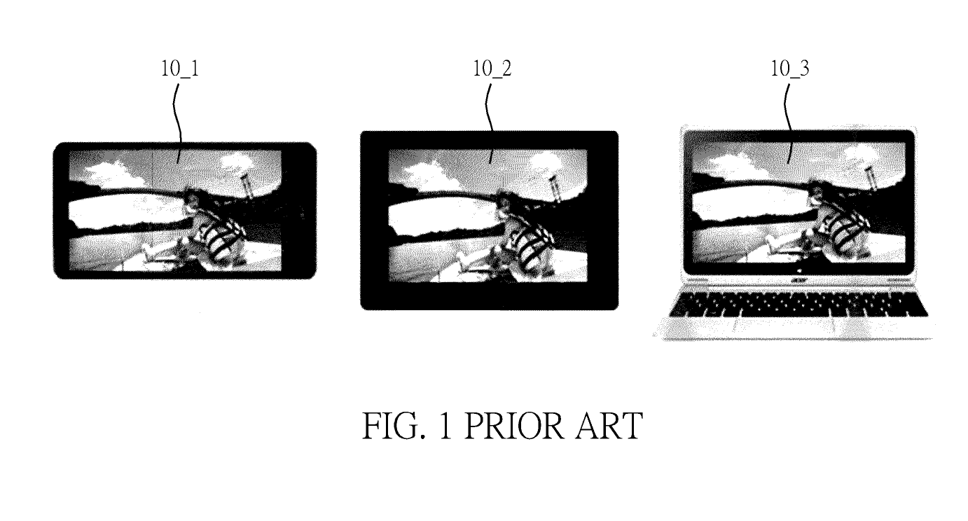

FIG. 2 is a schematic diagram of an electronic device according to an embodiment of the present invention.

FIG. 3 is a schematic diagram of a procedure according to an embodiment of the present invention.

FIG. 4 is a schematic diagram illustrating utilizing different display devices for displaying image according to an embodiment of the present invention.

### DETAILED DESCRIPTION

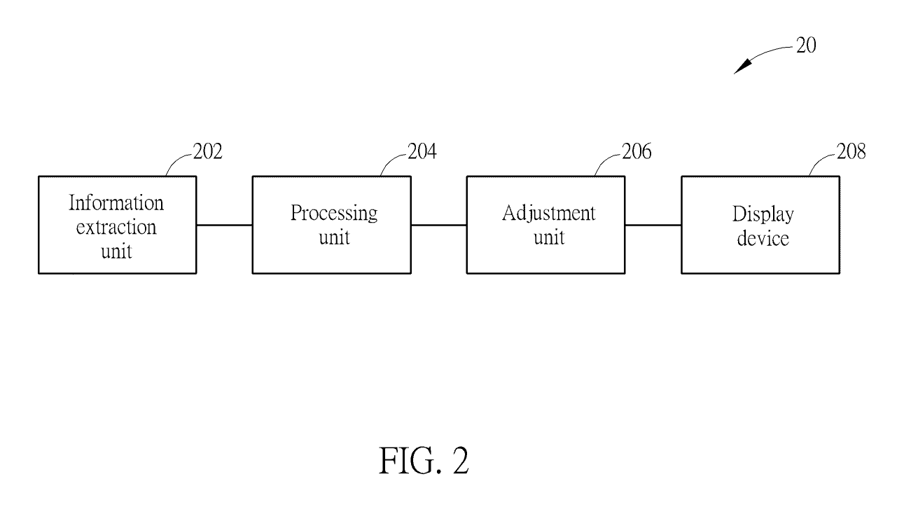

Please refer to FIG. 2, which is a schematic diagram of an electronic device 20 according to an embodiment of the present invention. The electronic device 20 includes an information extraction unit 202, a processing unit 204, an adjustment unit 206 and a display device 208. The information extraction unit 202 is utilized for acquiring environmental information during capturing an image and display characteristic information of the display device 208. The processing unit 204 is utilized for determining a display adjusting parameter according to the environmental information during capturing the image and the display characteristic information of the display device 208. The adjustment unit 206 is utilized for controlling the display device 208 for displaying the image according to the display adjusting parameter. Briefly, the electronic device 20 of the present invention can adjust the display adjusting parameter of the display device according to the environmental information during capturing the image and the display characteristic information of the display device 208, and thus achieving the consistent display effect while showing the same picture on different display devices.

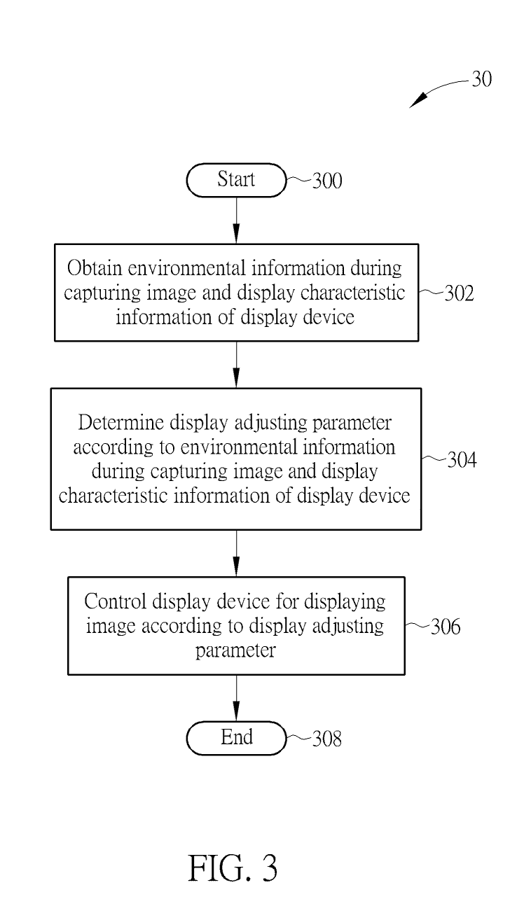

Regarding a display adjustment method of the electronic device 20, the display adjustment method may be summarized in an exemplary procedure 30. Please refer to FIG. 3, which is a schematic diagram of the procedure 30 according to an embodiment of the present invention. The procedure 30 includes the following steps:

Step 300: Start.

Step 302: Obtain environmental information during capturing image and display characteristic information of display device.

Step 304: Determine display adjusting parameter according to environmental information during capturing image and display characteristic information of display device.

Step 306: Control display device for displaying image according to display adjusting parameter.

Step 308: End.

According to the procedure 30, in Step 302, when the user wants to utilize the display device 208 of the electronic device 20 to display an image IMG, the electronic device 20 can receive a corresponding image file. The information extraction unit 202 can obtain the environmental information during capturing the image and the display characteristic information of the display device 208. The environmental information during capturing the image includes environmental color temperature information during capturing, environmental brightness information during capturing, and any other related environmental light source (light ray) information and/or scene information during capturing. The display characteristic information of the display device 208 includes color temperature information of the display device 208, color space information of the display device 208 and panel characteristic information associated with the display device 208.

On the other hand, when the image extraction device (such as the digital camera of the mobile phone) captures the image, the current environmental light source information, the current scene information and relevant information during capturing can be recorded and used as the environmental information during capturing the image for the following display adjustment. In addition, the environmental information during capturing the image can be stored in a header file of the image. For example, the captured image can be stored in Joint Photographic Experts Group (JPEG) file format, and the environmental information during capturing the image can be stored in the header segment of the corresponding JPEG image file with exchangeable image file format (Exif). Therefore, after receiving the image file, the information extraction unit 202 can extract the environmental information during capturing the image from the corresponding header segment of the image file. Moreover, the environmental information during capturing the image may be stored in a file which is different from the image file. As such, when the electronic device 20 displays the image file, the information extraction unit 202 will obtain the environmental information during capturing the image from the corresponding file.

In Step 304, the processing unit 204 determines a display adjusting parameter according to the environmental information during capturing the image and the display characteristic information of the display device 208. For example, the processing unit 204 determines a color tone mapping matrix according to the environmental information during capturing the image and the display characteristic information of the display device 208, and the adjustment unit 206 generates an adjusted display color value parameter corresponding the image IMG accordingly to the color tone mapping matrix. For example, if the environmental color temperature information during capturing a first picture image is M1, the environmental brightness information during capturing the first picture image is N1 and the screen color information of the display device 208 is Y1, the processing unit 204 can calculate a color tone mapping matrix A corresponding the first picture image accordingly. If the environmental color temperature information during capturing a second picture image is M2, the environmental brightness information during capturing the second picture image is N2 and the screen color information of the display device 208 is Y1, the processing unit 204 can calculate a color tone mapping matrix B corresponding the second picture image accordingly, and so on. In addition, the processing unit 204 may be implemented by a central processing unit of the electronic device 20 or other devices having the calculation function, but not limited thereto.

In Step 306, the adjustment unit 206 can control the display device 208 for displaying the image IMG according to the display adjusting parameter. For example, the adjustment unit 206 may be implemented by a graphics processing unit (GPU) of the electronic device 20 or other devices having the calculation function, but not limited thereto. In more detail, the adjustment unit 206 adjusts a display color value parameter of the display device 208 according to the display adjusting parameter, so as to generate an adjusted display color value parameter. The adjustment unit 206 drives the display device 208 for displaying the image IMG according to the adjusted display color value parameter. For example, assuming the display device 208 displays an image data according to a display color value parameter [R,G,B] originally. The adjustment unit 206 can transform the display color value parameter [R,G,B] to an adjusted display color value parameter [R′,G′,B′] according to formula (1), and the display device 208 displays the image IMG according to the adjusted display color value parameter [R′,G′,B′], wherein formula (1) is expressed as follow:

$$[ \begin{matrix}X 1 & X 2 & X 3 \\ X 4 & X 5 & X 6 \\ X 7 & X 8 & X 9\end{matrix} ] \times [ \begin{matrix}R \\ G \\ B\end{matrix} ] = [ \begin{matrix}{R}^{′} \\ {G}^{′} \\ {B}^{′}\end{matrix} ] \qquad ( 1 )$$

Wherein

$$[ \begin{matrix}X 1 & X 2 & X 3 \\ X 4 & X 5 & X 6 \\ X 7 & X 8 & X 9\end{matrix} ]$$

is the color tone mapping matrix which is determined by the processing unit 204 according to the environmental information during capturing the image IMG and the display characteristic information of the display device 208; [R,G,B] is the display color value parameter which the display device 208 originally refers to; [R′,G′,B′] is the adjusted display color value parameter calculated by the adjustment unit 206.

More specifically, assuming the RGB value of the captured red image is (255, 0, 0). Since the color shift or other characteristic deviation occurs in the display device 208, the display color value parameter about the red image is (250, 5, 5). That is, without display calibration, the display device 208 will output the image which the RGB value is (250, 5, 5) according to the display color value parameter for displaying the captured red image. Therefore, the user will watch a distorted image. To solve this problem, according to Step 304, the present invention determines the corresponding display adjusting parameter (such as the color tone mapping matrix of formula (1)) according to the environmental information during capturing the image and the display characteristic information of the display device 208. Then, according to Step 306, the present invention calculates the adjusted display color value parameter according to formula (1) by the adjustment unit 206. For example, the adjusted display color value parameter is (255, 0, 0). Therefore, when the display device 208 displays the captured red image, the display device 208 will display the correct and undistorted image IMG according to the adjusted display color value parameter.

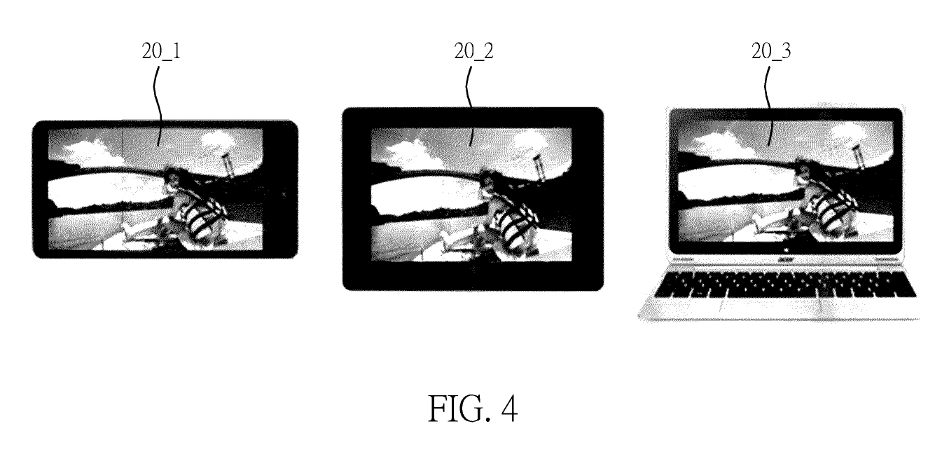

Further, referring to FIG. 4, the electronic devices 20_1˜20_3 are a mobile phone, a tablet computer and a notebook of the present invention respectively. Each electronic device respectively utilizes the display adjustment method of the procedure 30 to obtain the corresponding adjusted display color value parameter and displays the same picture image according to the corresponding adjusted display color value parameter. As shown in FIG. 4, the same picture image will have the consistent color display effect when displaying on the different display devices.

In an embodiment, if the picture image is stored in JPEG file format after capturing, and the environmental brightness information and the color temperature information during capturing the picture image are also stored in the header file of the picture image, when the electronic device 20 utilize the share scheme such as the community website, the cloud platform or else to transmit and obtain the picture image and the display device 208 displays the picture image, the information extraction unit 202 will read the header segment of the picture image file to obtain the environmental brightness information and the color temperature information of the picture image. Next, the processing unit 204 determines the display adjusting parameter according to the environmental information during capturing the image and the display characteristic information of the display device 208 obtained by the information extraction unit 202. The adjustment unit 206 adjusts a display color value parameter of the display device 208 to generate an adjusted display color value parameter according to the display adjusting parameter. Therefore, the display device 208 will display the correct and undistorted picture image according to the adjusted display color value parameter.

In an embodiment, if the electronic device 20 further has an image extraction device for capturing the image. When capturing the image, the display device 208 can be utilized for displaying previewing frame (not press the shutter key at this time). Meanwhile, the electronic device 20 can utilize the algorithm of camera to evaluate the current environmental color temperature and environmental brightness immediately, and provide the environmental color temperature information and environmental brightness information to the processing unit 204 for color calibration of the display device 208. Next, after the above operation of Step 304 and Step 306, the display device 208 will display the correct and undistorted picture image according to the adjusted display color value parameter.

In conclusion, the present invention adjusts the display adjusting parameter of the display device according to the environmental information during capturing the image and the display characteristic information of the display device, thus achieving the consistent display effect when showing the image indifferent display devices, and avoiding picture image distortion during displaying. In other words, when the image is displayed on different display devices, the present invention can provide color consistency of displaying the image and enforce the image reproducibility to improve the image distortion problem caused by the color shifted display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display adjustment method for a display device comprising:
obtaining environmental information during capturing an image and display characteristic information of the display device;
determining a display adjusting parameter according to the environmental information during capturing the image and the display characteristic information of the display device; and
controlling the display device for displaying the image according to the display adjusting parameter.

2. The display adjustment method of claim 1, wherein the step of displaying the image according to the display adjusting parameter comprises:
adjusting a display color value parameter of the display device to generate an adjusted display color value parameter according to the display adjusting parameter; and
driving the display device for displaying the image according to the adjusted display color value parameter.

3. The display adjustment method of claim 1, wherein the environmental information during capturing the image comprises at least one of environmental color temperature information and environmental brightness information during capturing.

4. The display adjustment method of claim 1, wherein the environmental information during capturing the image is stored in a header file of the image.

5. The display adjustment method of claim 1, wherein the display characteristic information of the display device comprises at least one of color temperature information and color space information of the display device.

6. An electronic device with display adjustment comprising:
a display device;
an information extraction unit for acquiring environmental information during capturing an image and display characteristic information of the display device;
a processing unit for determining a display adjusting parameter according to the environmental information during capturing the image and the display characteristic information of the display device; and
an adjustment unit for controlling the display device for displaying the image according to the display adjusting parameter.

7. The electronic device of claim 6, wherein the adjustment unit adjusts a display color value parameter of the display device to generate an adjusted display color value parameter according to the display adjusting parameter, and the adjustment unit drives the display device for displaying the image according to the adjusted display color value parameter.

8. The electronic device of claim 6, wherein the environmental information during capturing the image comprises at least one of environmental color temperature information and environmental brightness information during capturing.

9. The electronic device of claim 6, wherein the environmental information during capturing the image is stored in a header file of the image.

10. The electronic device of claim 6, wherein the display characteristic information of the display device comprises at least one of color temperature information and color space information of the display device.
